(19) United States
(12) Patent Application Publication
(10) Pub. No.: US 2007/0287403 A1
(43) Pub. Date: Dec. 13, 2007

(54) Radio-Receiver Front-End and A Method For Frequency Converting An Input Signal

(75) Inventor: Henrik Sjoland, Loddekopinge (SE)

Correspondence Address: POTOMAC PATENT GROUP PLLC, P. O. BOX 270, FREDERICKSBURG, VA, 22404, US

(73) Assignee: TELEFONAKTIEBOLAGET L M ERICSSON (PUBL), Stockholm (SE)

(21) Appl. No.: 11/571,614

(22) PCT Filed: Jul. 6, 2005
(86) PCT No.: PCT/EP05/07282

§ 371 Date: Aug. 7, 2007

(30) Foreign Application Priority Data
Jul. 6, 2004 (EP) 04015808.1

(51) Int. Cl. H04B 1/26

(52) U.S. Cl. 455/326; 455/313

(57) ABSTRACT

An N-phase radio receiver front-end for converting an input signal having a first frequency to output signals having a second frequency, and a method for converting an input signal in an N-phase radio receiver front-end. An input port of the N-phase radio receiver front-end is directly connected to an input port of a low noise amplifier (50). A mixer arrangement (50a) is a current mode mixer arrangement. An output port of the low-noise amplifier is directly connected to an input port of the mixer arrangement. A signal generator operatively connected to the mixer arrangement is adapted to generate N phase shifted local oscillator signals.

### TECHNICAL FIELD OF THE INVENTION

The present invention relates to an N-phase radio receiver front-end for converting an input signal having a first frequency to an output signal having a second frequency. The invention also relates to a method for converting an input signal having a first frequency to an output signal having a second frequency.

### DESCRIPTION OF RELATED ART

Conventional radio receiver front-end design incorporates conversion of incoming radio frequency (RF) signals to one or more intermediate frequency (IF) signals, the last of which is then converted to base band. The radio receiver front-end may comprise a low noise amplifier (LNA) with a substantial voltage gain. Following the low noise amplifier, one or several mixers is/are provided for converting the input signal to the IF signal(s), which is/are provided at the output of the mixer(s).

A quadrature radio receiver front-end is designed to mix a differential or single-ended input signal with four local oscillator signals having different phase, and provide two output signals, one for I-channel and one for Q-channel.

The input signal may comprise superimposed out-of-band interference. In radio receiver front-ends known in the art, one or several filters for processing the input signal is/are provided. A pre-filter, such as a band-select filter, is provided before the LNA to suppress the out-of-band interference. Additional filters may also be provided for processing the input signal. To make the radio receiver front-end cheap, it may be implemented as part of an integrated circuit. However, filters are difficult to implement with on-chip design. Thus, the filters must often be implemented off-chip. This is a disadvantage as off-chip components make the radio receiver front-end more expensive, larger and complex. Consequently, in the development towards smaller and less expensive radio receivers most of the off-chip filters have been removed. In today's homodyne receivers, one off-chip filter remaining is the band-select filter. If also the band-select filter could be removed, substantial costs and space could be saved. This is especially true for multi-band radio receiver front-ends requiring one band-select filter per band. If also multiple antennas are used, the impact is even higher.

If the pre-filter, such as the band-select filter, is simply removed, strong out-of-band interference could saturate the radio receiver. Also, it would cause intermodulation distortion and compression of the input signal. Different communication standards have different requirements of maximum out-of-band interference. To fulfill the requirements according to e.g. the GSM (Global System for Mobile communication) standard, out-of-band interference of up to 0 dBm must be handled. A conventional radio receiver front-end does not fulfill this requirement without a pre-filter, such as a band-select filter.

In some radio receiver front-end designs, the band-select filter may be integrated on-chip. However, this solution does not fulfill the maximum out-of-band requirements of different mobile communication standards, such as the GSM or the UMTS (Universal Mobile Telecommunication Standard) standards.

### SUMMARY OF THE INVENTION

It is therefore an object of the invention to provide a radio receiver front-end which is less complex than radio receiver front-ends known in the art, and which may be implemented with on-chip technology. It is also an object of the invention to provide a method for converting an input signal having a first frequency to an output signal having a second frequency.

According to a first aspect of the invention, these objects are achieved by an N-phase radio receiver front-end according to the invention, which neither has an on-chip nor an off-chip band-select filter.

The N-phase radio receiver front-end according to the invention comprises a low noise amplifier, a mixer arrangement, and a signal generator. An input port of the N-phase radio receiver front-end is directly connected to an input port of the low noise amplifier. The mixer arrangement is a current mode mixer arrangement, as the input signal has not been converted to voltage before mixing. An output port of the low noise amplifier is directly connected to the input port of the mixer arrangement. The signal generator is adapted to generate N phase shifted local oscillator signals. The phase shifted local oscillator signals may be used for selectively activating mixer cores of the mixer arrangement.

The mixer arrangement may comprise N/2 mixer cores. Each mixer core may have an input terminal directly connected to the input port of the mixer arrangement. The mixer cores may be single-balanced or double-balanced mixer cores.

The low noise amplifier may be a single ended or a differential amplifier.

The output port of the mixer arrangement may be connected to an active or passive frequency selective load. The frequency selective load may comprise N/2 current to voltage conversion means, whereby out-of-band interference of a signal input to the radio receiver front-end may be suppressed.

Each current to voltage conversion means may comprise a mixer load connected to a respective output terminal of the mixer cores and signal grounding means, respectively. Each mixer load may be a resistor connected in parallel with a capacitor. The capacitor of each mixer load has a value, which is effective for suppressing out-of-band interference of a signal input to the radio receiver front-end when said signal has been mixed. The capacitance of the capacitor of each mixer load may be variable for suppressing out-of-band interference of input signals having different bandwidths.

The signal generator may be an oscillator for providing signals for driving the mixer cores. The oscillator may be a voltage controlled oscillator The mixer arrangement may be connected to the voltage controlled oscillator by means of transformers for providing local oscillator signals, such as quadrature local oscillator signals. Supplying the local oscillator signals by means of transformers is an advantage as no low-frequency noise will be introduced to the local oscillator terminals of the mixer arrangement.

The local oscillator may comprise quadrature oscillators with LC-tanks. Inductors of the LC-tanks may provide primary windings of the transformers, and inductors connected to local oscillator input terminals of the mixer may provide secondary windings of said transformers. Thus, no additional components are needed for providing the transformers except the inductors for providing the secondary windings.

The capacitor of each LC-tank may be a variable capacitor for adjusting the frequency of the local oscillator signals.

Alternatively, the signal generator may be provided by a high frequency oscillator and a frequency divider arranged to provide N non-overlapping local oscillator signals having a duty cycle of substantially 1/N. With quadrature oscillator signals, the duty cycle should be substantially 25% for each signal.

According to a second aspect of the invention, the objects are achieved by the use of the N-phase radio receiver front-end according to the invention in a wireless electronic communication apparatus for converting an input signal having a first frequency to a signal having a second frequency.

According to a third aspect of the invention, the objects are achieved by a wireless electronic communication apparatus comprising a N-phase radio receiver front-end according to the invention.

According to a fourth aspect of the invention, the objects are achieved by a method for converting an input signal having a first frequency to an output signal having a second frequency in an N-phase radio receiver front-end. The method comprises the steps of receiving the input signal at an input port of the radio receiver front-end; amplifying the input signal comprising out-of-band interference in a low noise amplifier; mixing the input signal and the out-of-band interference with a plurality of phase shifted local oscillator signals having a second frequency in a current mode mixer arrangement to generate a mixed signal having the second frequency.

The mixed signal may comprise out-of-band interference. The method may further comprise the step of suppressing the out-of-band interference of the mixed signal.

The step of suppressing may comprise supplying the mixed input signal comprising the out-of-band interference to a passive or active frequency selective load. The frequency selective load may be a mixer load, which is connected to a respective output terminal of the mixer arrangement and signal grounding means, respectively. The mixed signal may be an IF signal.

The step of suppressing may comprise suppressing by means of a capacitor of the mixer load, which has a value that is effective for suppressing out-of-band interference of the mixed signal.

The method may comprise adjusting the capacitance of the capacitor, which may be a variable capacitor, of the frequency selective load for suppressing out-of-band interference of mixed input signals having different bandwidths.

The method may also comprise the steps of generating the local oscillator signals, and supplying said generated local oscillator signals to N/2 mixer cores of the mixer arrangement.

Further, the method may comprise adjusting the capacitance of a capacitor of an oscillator connected to the mixer arrangement for adjusting the frequency of said local oscillator signals.

Further embodiments of the invention are defined in the dependent claims.

It is an advantage of the invention that the size and complexity of the radio receiver front-end is reduced compared to conventional radio receiver front ends.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Further objects, features and advantages of the invention will appear from the following detailed description of the invention, reference being made to the accompanying drawings, in which:

FIG. 1 is a front view of a mobile communication apparatus comprising a N-phase radio receiver front-end according to the invention;

FIG. 2 is a block-diagram of the N-phase radio receiver front-end according to the invention;

FIG. 3 is a circuit-diagram of an embodiment of the N-phase radio receiver front-end according to the invention;

FIG. 4a is a circuit-diagram of a first embodiment of a voltage controlled oscillator for generating low noise local oscillator signals;

FIG. 4b is a signal diagram of local oscillator signals;

FIG. 5a is a block-diagram of a high frequency oscillator connected to frequency dividers for generating low noise local oscillator signals;

FIG. 5b is a signal diagram of local oscillator signals;

FIG. 6 is a circuit-diagram of another embodiment of the N-phase radio receiver front-end according to the invention; and

FIG. 7 is a flow-chart of one embodiment of the method according to the invention.

### DETAILED DESCRIPTION OF EMBODIMENTS

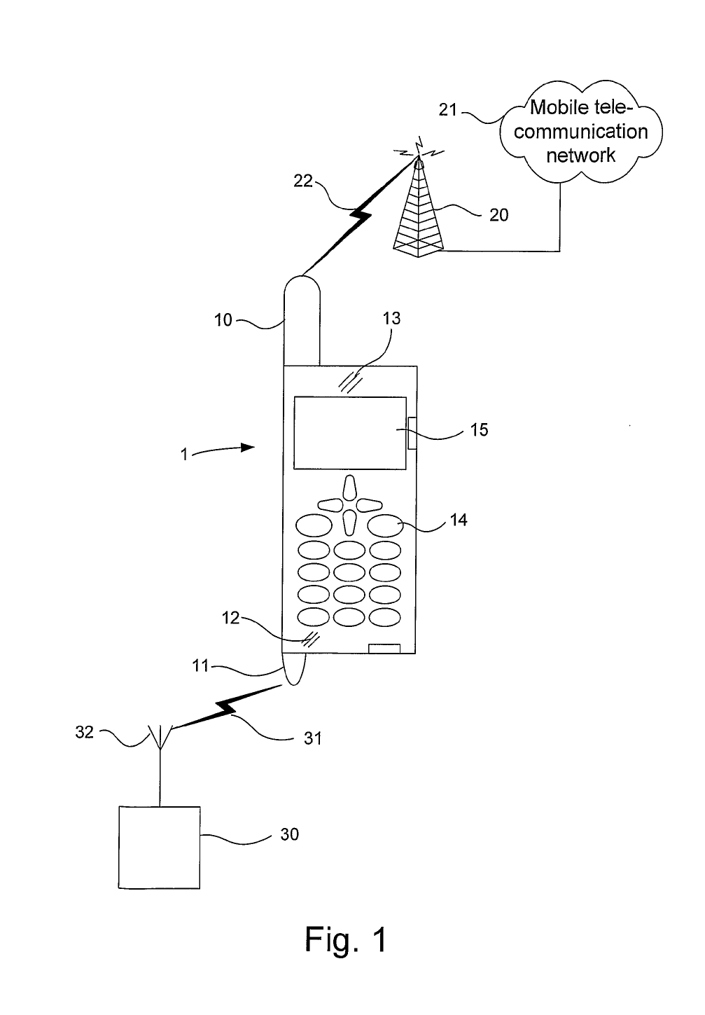

FIG. 1 illustrates a mobile telephone 1 as one exemplifying wireless electronic communication apparatus, in which an N-phase radio receiver front-end according to the present invention may be utilized. The invention is not limited to implementation in a mobile telephone 1. The invention may be implemented in a wide variety of electronic equipment wherein a radio receiver front-end is required for receiving and processing radio frequency (RF) input signals, such as a mobile radio terminal, a pager, a communicator, an electronic organizer or a smartphone. The mobile telephone 1 may comprise a first antenna 10 and a second auxiliary antenna 11 for receiving input signals. A microphone 12, a loudspeaker 13, a keypad 14, and a display 15 provide a man-machine interface for operating the mobile telephone 1.

The mobile telephone may in operation be connected to a radio station 20 (base station) of a mobile communication network 21, such as a GSM, UMTS, PCS (Personal Communications System), and/or PDC (Personal Digital Cellular), via a first radio link 22 by means of the first antenna 10. Furthermore, the mobile telephone 1 may in operation establish a second wireless link to a peripheral device 30 via a second radio link 31 by means of the auxiliary antenna 11. The second radiolink 31 is e.g. a Bluetooth® link, which is established in the 2.4 (2.400-2.480) GHz frequency range. To establish the radio links 22, 31, the mobile telephone 1 comprises radio resources, which are adapted according to the relevant technologies that are used. Thus, the mobile telephone 1 comprises a first radio access means, such as a transceiver, for communicating radio signals with the base station 20, and a second radio access means for communicating radio signals with the peripheral device 30. Alternatively, one radio access means may be switchable to communicate radio signals with either the base station 20 or the peripheral device 30.

The peripheral device 30 may be any device having wireless communicating capabilities, such as according to Bluetooth® technology or any other wireless local area network (WLAN) technology. It comprises an antenna 32 for exchanging signals over the second link 31, and a transceiver (not shown) adapted according to the communication technology that the peripheral device 30 uses. The device may be a wireless headset, a remote server, a fax machine, a vending machine, a printer, a computer etc. A wide variety of electronic equipment may have such communication capabilities and have a need for wirelessly transferring data.

Received input signals having radio frequencies (RF), may be processed by the radio receiver front-end according to the invention. The input signals may be single-ended or differential. The input signals are converted to intermediate frequency (IF) signals before further signal processing is applied. Thus, the radio receiver front-end of the mobile telephone 1 may comprise a mixer arrangement comprising one or several mixer cores for converting a signal having a first frequency to signals having a second frequency as will be disclosed in the following.

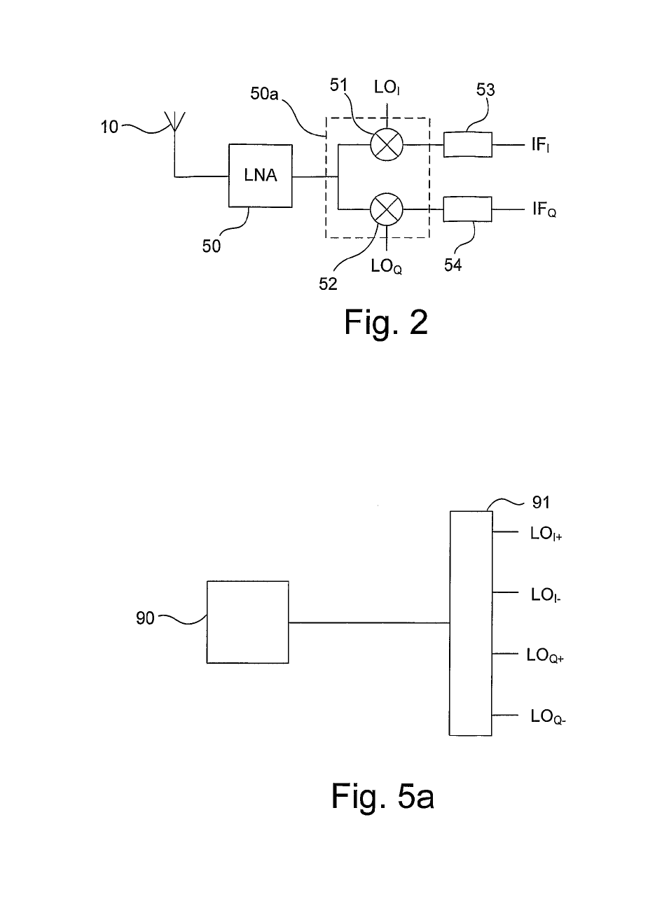

FIG. 2 illustrates the radio receiver front-end according to the invention. The antenna 10 may be directly connected to an input port of a low noise amplifier (LNA) 50. The LNA 50 is inherently linear or linearized, such that it can handle out-of band interference, e.g. according to the GSM standard, wherein out-of-band interference up to at least 0 dBm should be handled. The RF signal input to the LNA 50 comprises both the desired signal and superimposed out-of-band interference, which are amplified by the gain of the LNA 50.

A current input port of an N-phase mixer arrangement 50a is connected to an output port of the LNA 50. The mixer arrangement 50a may comprise N/2 mixer cores 51, 52. In the embodiments of FIGS. 2, 3 and 6, quadrature radio receiver front-ends are described. These mixer arrangements 50a comprises a first and a second mixer core 51, 52 having input terminals. Each input port and output port of the mixer arrangement 50a and the LNA 50 may comprise one or several terminals.

The first mixer core 51 may be used for the I-channel of the input signal and the second mixer core 52 may be used for the Q-channel of the input signal. The output port of the LNA 50 is directly connected to the input port of the mixer arrangement 50a, i.e. the signal current from the LNA 50 is not converted to a voltage by a load impedance. With a 0 dBm interferer, a signal converted to a voltage would be too large to handle. The mixing is therefore performed in the current domain according to the invention by controlling the mixer by means of the phase shifted LO signals for selectively activating the mixer arrangement 50a, e.g. by selectively activating the mixer cores 51, 52. Thus, the interferer may be handled.

Each mixer core 51, 52, and thus the mixer arrangement 50a, also comprises local oscillator (LO) input terminals for receiving LO signals, which are generated by an LO signal generating means or LO signal generator, to be mixed with the amplified input signal. The first mixer core 51 is adapted to receive a first LO signal LO_{I} having a first phase, to which it is responsive. The second mixer core 52 is adapted to receive and be responsive to a second LO signal LO_{Q} having a second phase, which is different from the first phase.

Output ports of the mixer arrangement 50a, e.g. output terminals of the first and the second mixer core 51, 52 may be connected to an active or passive frequency selective load.

The frequency selective load may comprise a first and a second current to voltage conversion means 53, 54. Thus, the input signal, which now is amplified and mixed to lower frequency signals, may be converted to voltage by the current to voltage conversion means. Thus, I- and Q-channel output signals IF_{I}, IF_{Q} may be provided at output ports of the frequency selective load. Each output port of the frequency selective load may comprise first and second terminals.

The frequency selective load will also function as a suppression means for suppressing the out-of-band interference.

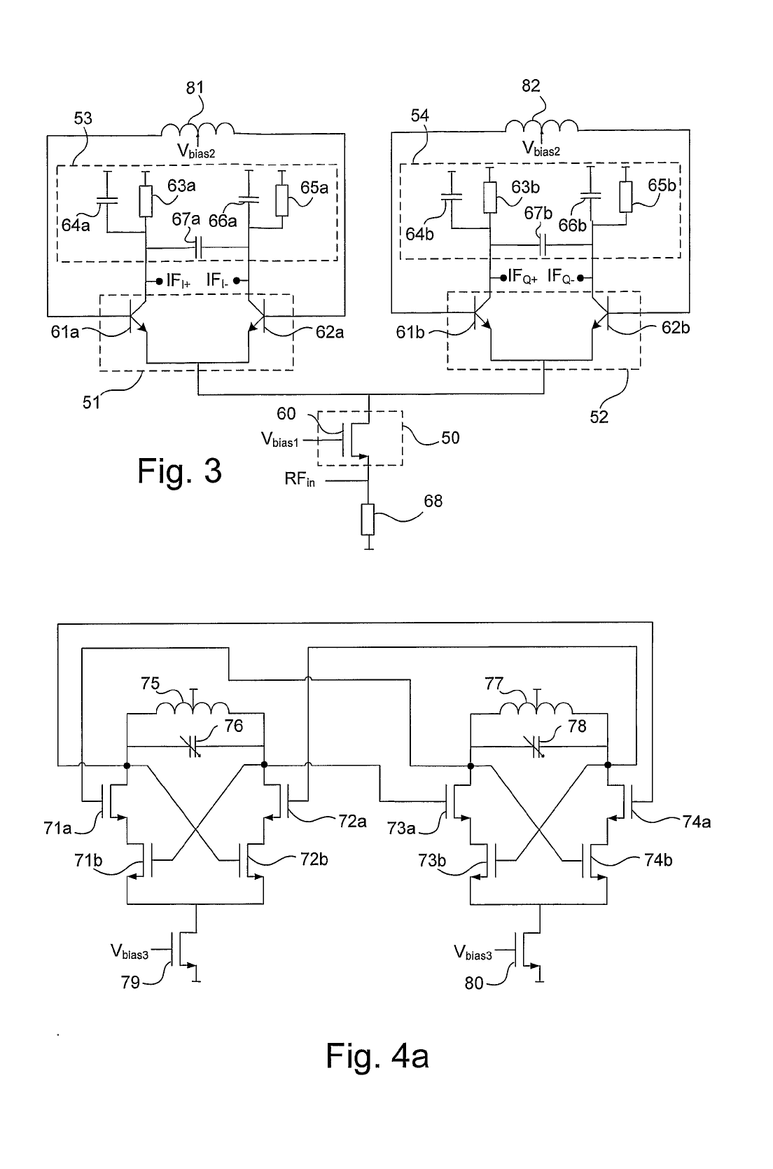

FIG. 3 is a circuit-diagram of one embodiment of the N-phase radio receiver front-end according to the invention, wherein N=4. Thus, the radio receiver front-end according to FIG. 3 is a quadrature radio receiver front-end. With the design according to the invention it is of importance that the linearity of the LNA is sufficiently high to handle out-of-band interference of e.g. up to 0 dBm, as described above. In the embodiment of FIG. 3, the LNA is a common gate or common base LNA provided by an amplifier transistor 60, which may be an input transistor. The transistor 60 may be an FET (Field Effect Transistor), such as an MOS (Metal Oxide Semiconductor) transistor or a BJT (Bipolar Junction Transistor) transistor. In the embodiment of FIG. 3, the LNA 50 is provided by an FET transistor. The input port of the quadrature radio receiver front-end is connected to the source terminal of transistor 60.

The gate of amplifier transistor 60 is connected to a bias voltage V_{bias1}. Alternatively, a bias input (gate) of the amplifier transistor 60 is connected to a common mode feedback circuit for controlling the bias of said amplifier transistor 60.

As the mixer cores 51, 52 and the first and second current to voltage conversion means 53, 54 have similar design, only the first mixer core 51 and the associated first current to voltage conversion means 53 will be described in detail in the following. The first mixer core 51 may comprise first and second mixer transistors 61a, 62a connected to the input terminal of the first mixer core 51. The mixer transistors 61a, 62a may be FET transistors or BJT transistors. It is an advantage of the BJT transistor that it is quicker than the FET transistor, which provides a higher linearity. In the embodiment of FIG. 3, the mixer transistors 61a, 62a are provided by BJT transistors. The emitter of each mixer transistor 61a, 62a is connected to the input terminal of the first mixer core 51. The base of each mixer transistor is connected to an LO (Local Oscillator) input terminal of the first mixer core 51. Each mixer transistor 61a, 62a is responsive to a respective quadrature LO signal. The first mixer transistor 61a is responsive to a first quadrature LO signal LO_{I+} having a first phase. The second mixer transistor 62a is responsive to a second LO signal LO_{I-} having a second phase, which is phase shifted 180° relative the first phase. The collectors of the mixer transistors 61a, 62a are connected to first and second output terminals, respectively, of the first mixer core 51.

The frequency selective load, e.g. the current to voltage conversion means, may comprise a capacitor 67a provided between the input terminals of the frequency selective load. Thus, the frequency selective load will be operative for filtering of out-of-band interference and to provide some channel filtering.

The mixer arrangement 50a and the mixer cores 51, 52 are current mode mixers operating in the current domain. The output signals from the first mixer core 51 are supplied to the frequency selective load. The frequency selective load may comprise the first current to voltage conversion means 53, which may convert the output signals from the first mixer core 51 to voltage. The first current to voltage conversion means 53 may comprise separate conversion means for each output signal. Each conversion means may comprise passive components, such as resistors 63a, 65a and capacitors 64a, 66a connected in parallel to the output terminals of the first mixer core 51 and signal grounding means, such as supply voltage. The first mixer transistor 61a is connected to resistor 63a and capacitor 64a, and the second mixer transistor 62a is connected to resistor 65a and capacitor 66a.

The first and second current to voltage conversion means may also comprise active components. For example a transistor connected as a resistor may replace resistor 63a and/or resistor 65a. Alternatively, the first and second current to voltage conversion means 53, 54 may comprise transimpedance amplifiers to convert the current signal output from the mixer arrangement 50a. The transfer function of such a transimpedance amplifier can be made frequency selective.

A first IF (Intermediate Frequency) output signal IF_{I} for the I-channel may be generated between the output terminals of the first mixer core 51. The desired signal, which may be centered at low frequencies, is not significantly attenuated by the capacitors 64a, 66a and 67a. The out-of-band interference, however, which in GSM will occur at a frequency of at least 20 MHz offset from the desired signal, may be heavily attenuated by choosing suitable values of capacitors 64a, 66a and 67a. Furthermore, LO to IF leakage is suppressed by capacitors 64a, 66a and 67a, enabling the use of single balanced mixer cores and a single-ended LNA. A single-ended LNA removes the need of an external balun. An external filter may perform the balun function. Thus, if a differential LNA is utilized, a stand alone external balun may need to be provided. The signals after the radio receiver front-end are differential, which is suitable for further processing on-chip.

The LNA 50 may alternatively be provided by a feedback LNA, which is sufficiently linear for handling out-of-band interference of up to 0 dBm for satisfying the GSM standard. However, the linearity requirement has to be considered in each specific case.

The second mixer core 52 may comprise first and second mixer transistors 61b, 62b, and is configured as the first mixer core 51. The second current to voltage conversion means 54 comprises a mixer load provided by resistors 63b, 65b and capacitors 64a, 66b, and a capacitor 67b arranged between the input terminals of the second current to voltage conversion means 54. The first mixer transistor 61b of the second mixer core 52 is responsive to a third quadrature LO signal LO_{Q+} having a third phase, which is phase shifted 90° relative the first phase. The second mixer transistor 62b of the second mixer core 52 is responsive to a fourth LO signal LO_{Q-} having a fourth phase, which is phase shifted 270° relative the first phase. The collectors of the mixer transistors 61b, 62b of the second mixer core 52 are connected to first and second output terminals of the second mixer core 52.

A second IF (Intermediate Frequency) output signal IF_{Q} for the Q-channel may be outputted between the output terminals of the second mixer core 52.

To provide bias current to the radio receiver front-end, a current device 68 is connected to the input port of the radio receiver front-end and the input port of the LNA 50. The current device 68 may e.g. be provided by a resistor, an inductor, or a transistor connected as a current source. An inductor has the advantage that it causes a lower voltage drop than a resistor or transistor connected as a current source. Also, if current device 68 is provided by an inductor it can tune out parasitic capacitance appearing at the source of transistor 60.

The LO input terminals of the first and second mixer cores 51, 52 are connected to an LO signal generator. In one embodiment, the LO signal generator is a quadrature LO signal generating means. Since the signal to out-of band interference ratio is not improved by filtering before the input signal is supplied to the mixer arrangement 50a, the phase-noise of the LO signals must be very low at large offset frequencies, e.g. above 20 MHz in a GSM implementation. If the phase-noise is too high, reciprocal mixing of strong out-of-band interference can block the reception of weak signals. In the GSM case, the requirement of the phase-noise will be similar to what is needed in a transmitter. Thus, the same or a similar oscillator may be used for generating the LO signals LO_{I+}, LO_{I-}, LO_{Q+}, LO_{Q-} for the transmitter and the radio receiver front-end. The low-frequency local oscillator noise must also be low, since it is directly transferred to the IF outputs.

The signal generator may comprise an oscillator, such as a VCO (Voltage Controlled Oscillator).

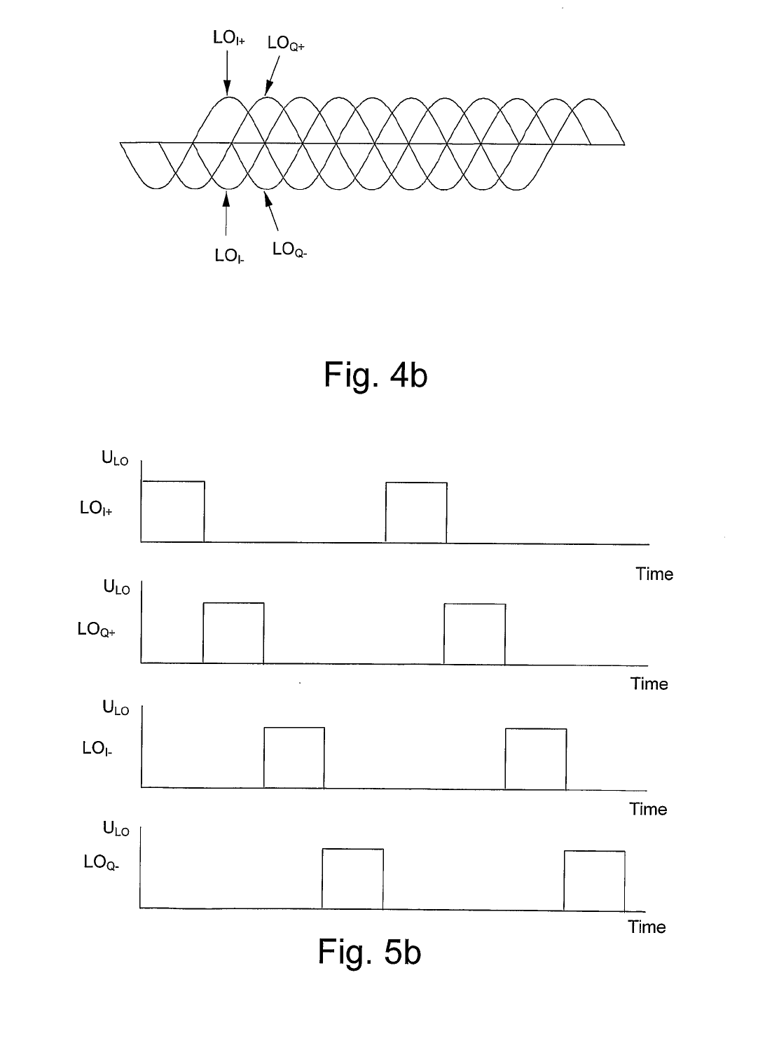

FIG. 4a illustrates one embodiment of a VCO (Voltage Controlled Oscillator), which may be used for generating quadrature LO signals. A possibility to generate low phase-noise local oscillator signals substantially free from low-frequency noise is to use oscillators with LC-tanks. The LC-tanks may be part of transformers having secondary windings connected to the mixer cores 51, 52. No local oscillator buffers are needed in this case, and the DC-level of the local oscillator signal fed to the mixer cores may easily be set. The VCO comprises four pairs of transistors 71a, 71b, 72a, 72b, 73a, 73b, 74a, 74b. Said transistors may be provided by FET or BJT transistors.

The source of transistor 71a is connected to the drain of transistor 71b. The gate of transistor 71a is connected to the drain of transistor 73a, and the drain of transistor 71a is connected to a first LC-tank comprising an inductor 75 connected in parallel with a capacitor 76. The center tap of inductor 75 is connected to the supply voltage. The value of capacitor 76 will set the frequency of the VCO. The gate of transistor 71b is connected to the drain of transistor 72a and to the gate of transistor 73a. The source of transistor 71b is connected to the drain of a bias transistor 79. The gate of bias transistor 79 will in operation receive a bias voltage V_{bias3}. The source of bias transistor 79 is connected to grounding means.

The drain of transistor 72a is connected to second terminals of inductor 75 and capacitor 76, and to the gate of transistor 73a and 71b. The gate of transistor 72a is connected to the drain of transistor 74a. The source of transistor 72a is connected to the drain of transistor 72b. The gate of transistor 72b is connected to the drain of transistor 71a and to the gate of transistor 74a. The source of transistor 72b is connected to the drain of bias transistor 79.

The source of transistor 73a is connected to the drain of transistor 73b. The gate of transistor 73a is connected to the drain of transistor 72a, and the drain of transistor 73a is connected to a second LC-tank comprising an inductor 77 connected in parallel with a capacitor 78, and to the gate of transistor 71a. The center tap of inductor 77 is connected to the supply voltage. The value of capacitor 78 should track that of capacitor 76 and it will set the frequency of the VCO. The gate of transistor 73b is connected to the drain of transistor 74a and to the gate of transistor 72a. The source of transistor 73b is connected to the drain of a bias transistor 80. The gate of bias transistor 79 will in operation receive the bias voltage V_{bias3}. The source of bias transistor 80 is connected to grounding means.

The drain of transistor 74a is connected to second terminals of inductor 77 and capacitor 78, and to the gate of transistor 72a and 73b. The gate of transistor 74a is connected to the drain of transistor 71a. The source of transistor 74a is connected to the drain of transistor 74b. The gate of transistor 74b is connected to the gate of transistor 71a and to the drain of transistor 73a. The source of transistor 74b is connected to the drain of bias transistor 80.

The VCO is magnetically coupled to the LO input terminals of the mixer cores 51, 52 by means of first and second transformers. The first transformer comprises inductor 75 and an inductor 81 connected to the gate of transistor 61a and the gate of transistor 62a. The primary winding of the first transformer is provided by inductor 75, and the secondary winding thereof is provided by inductor 81. Similarly, the second transformer comprises inductor 77 and an inductor 82 connected to the gate of transistor 61b and to the gate of transistor 62b.

Supplying the LO signals LO_{I+}, LO_{I-}, LO_{Q+}, LO_{Q-} to the mixer transistors 61a, 61b, 62a, 62b through the transformers means that no low-frequency noise will be applied to the LO input terminals of the mixer cores 51, 52. Inductor 81 and 82 will short out any low-frequency noise at the LO input terminals. Furthermore, the transformer will not consume any current, as it only comprises passive components, which is an advantage if low power consumption is of importance.

FIG. 4b illustrates the LO signals, which may be generated by the VCO according to the embodiment of FIG. 4a. At each instant, the LO signal having the highest voltage level will dominate the other LO signals, except at the crossings of the LO signals, due to the phase shifting of the signals. This means that it is possible to interconnect the input terminals of the mixer cores 51, 52. The transistor receiving the LO signal having the highest voltage level will be conducting and thus operative. Furthermore, the transistor receiving the LO signal having the highest voltage level will dominate over the other transistors of the mixer arrangement 50a even if any of the other transistors are conducting to a certain extent.

FIG. 5a illustrates an alternative solution for generating the LO signals LO_{I+}, LO_{I-}, LO_{Q+}, LO_{Q-} with sufficiently low phase-noise and low-frequency noise, which are phase shifted relative each other. The LO signals are phase shifted in this embodiment such that substantially only one signal will be in the high state at the time. A high frequency oscillator 90 is connected to a digital frequency divider 91. In this embodiment, the frequency divider is arranged to generate quadrature LO signals, i.e. the four LO signals LO_{I+}, LO_{I-}, LO_{Q+}, LO_{Q-}, of which only one is active at a time. The frequency of the high frequency oscillator should at least be twice the frequency of the output signals from the digital frequency divider 91. It is important to avoid time overlaps when more than one of the four local oscillator signals are simultaneously high. The overlaps can be avoided by arranging the frequency divider 91 to provide an approximate duty cycle of 1/N, i.e. 25% for quadrature signals, for each of the output signals. If overlaps exist, additional noise is generated and the sensitivity to matching inaccuracy of the mixer transistors is increased. However, if the noise requirement is less strict some overlap may be allowed. It is an advantage of the high frequency oscillator 90 and the digital frequency divider 91 that they provide a more compact design, albeit with increased current consumption compared to the VCO implementation of FIG. 4a.

The frequency divider 91 may be provided by a Johnson counter with N flip-flops in series, where the output signal of the last flip-flop is fed back to the input terminal of the first one. All flip-flops should be clocked by the same clock signal of N times the frequency of the output signal. The flip-flops have to be forced to a state where only one output is high at the time to avoid loops of false states. The N LO signals can then be extracted at the outputs of the N flip-flops.

FIG. 5b illustrates phase shifted LO signals, wherein N=4, generated by the frequency divider 91. The LO signals may be square waves, which are substantially non-overlapping.

In the above description, the input signal RFᵢₙ is single ended. However, the input signal may equally well be differential, wherein the LNA 50 will be arranged to amplify the differential signal, which is then supplied to double balanced mixer cores instead of single balanced mixer cores as described above.

The radio receiver front-end as described above may be adapted to dual mode mobile communication, wherein it may handle incoming signals from at least two mobile communication networks applying different communication standards, such as GSM and UMTS. A dual mode radio receiver front-end may be provided by arranging two radio receiver front-end circuits as disclosed above in parallel, wherein each front-end is adapted according to a specific standard. The parallel-connected circuits may be selectively activated by biasing the LNA of each radio receiver front-end circuit selectively. A controller may be arranged to control the biasing of the LNA of each circuit.

Alternatively, a dual mode radio receiver front-end may be provided by changing the bandwidth of the frequency selective load, e.g. of the current to voltage conversion means 53, 54. Thus, if the capacitors 64a, 64b, and 67a are variable capacitors having selectively variable capacitance values, a controller may be arranged to set specific values of the capacitors 64a, 64b, and 67a. The value set will be chosen such that out-of-band interference of input signals of different received signal bandwidths will be suppressed and the signal to be received is essentially unaffected.

According to the invention, a topology for making the LNA 50 and the mixer arrangement 50a sufficiently linear for handling out-of-band interference is chosen. If the LNA and the mixer arrangement were not sufficiently linear, the out-of-band interference would cause intermodulation distortion and compression of the input signal as the band-select-filter is removed according to the invention.

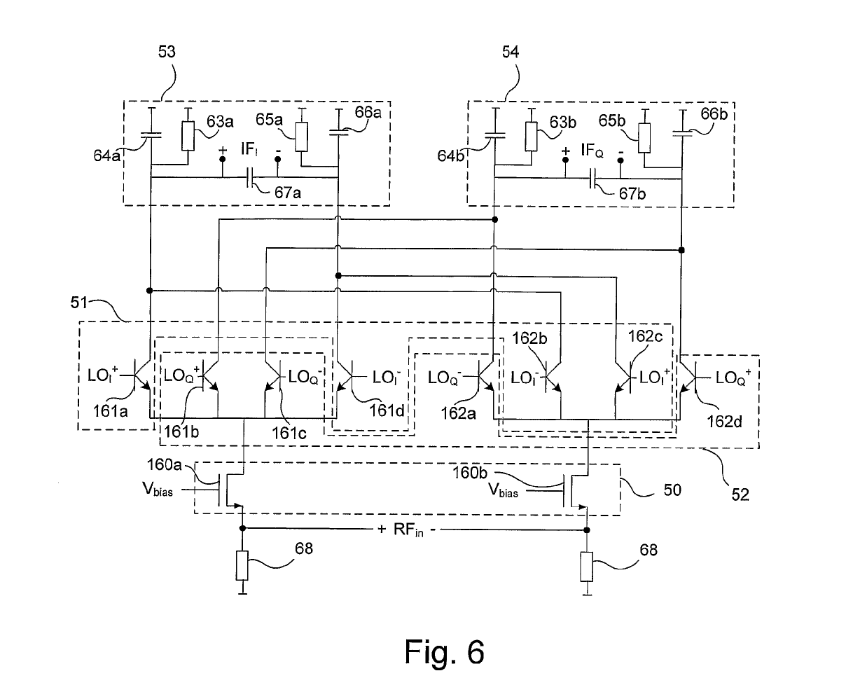

FIG. 6 is a circuit-diagram of another embodiment of the N-phase radio receiver front-end according to the invention. In the embodiment shown, N=4, i.e. it is a quadrature radio receiver front-end. Components that correspond to components of the embodiment FIG. 3 are denoted by the same reference numerals and will not be described in relation to the embodiment of FIG. 6. However, even if the components correspond, it should be noted that the values thereof may differ depending on the actual implementation.

The radio receiver front-end illustrated in FIG. 6 comprises a double balanced mixer arrangement with a differential LNA. The differential amplifier comprises a first and a second amplifier means, e.g. provided by a first and a second amplifier transistor 160a, 160b, such as a MOS or BJT transistor. The input port of the quadrature radio receiver front-end is connected to the input port of the LNA 50, which is directly connected to source terminals of transistors 160a, 160b, to which an input signal RFᵢₙ may be applied.

The gates of transistors 160a and 160b are connected to a bias voltage V_{bias}. Alternatively, the bias input (gate) of transistors 160a and 160b may be connected to a common mode feedback circuit for controlling the bias of said transistors 160a, 160b (not shown).

The first and the second mixer cores 51, 52 according to the embodiment of FIG. 6 each comprise four mixer transistors 161a, 161b, 161c, 161d, 162a, 162b, 162c, 162d. The gates of transistors 161a and 162c are connected to receive the local oscillator signal LO_{I+}. The gates of transistors 161b and 162d are connected to receive the local oscillator signal LO_{Q+}. The gates of transistors 161c and 162a are connected to receive the local oscillator signal LO_{Q-}. The gates of transistors 161d and 162b are connected to receive the local oscillator signal LO_{I-}.

The drains of transistors 161a and 162b are connected to a first terminal of capacitor 64a, resistor 63a and capacitor 67a. The drains of transistors 161b and 162a are connected to a first terminal of capacitor 64b, resistor 63b and capacitor 67b. The drains of transistors 161c and 162d are connected to a first terminal of capacitor 66b and resistor 65b and to a second terminal of capacitor 67b. The drains of transistors 161d and 162c are connected to a first terminal of capacitor 66a and resistor 65a, and to a second terminal of capacitor 67a.

The first output signal IF_{I} will during operation be generated between output terminals connected to the terminals of capacitor 67a, and the second output signal IF_{Q} will be generated between output terminals connected to the terminals of capacitor 67b.

The local oscillator signals LO_{I+}, LO_{I-}, LO_{Q+}, LO_{Q-} may be provided according to the principles as described in relation to FIG. 4a-4b or 5a-5b.

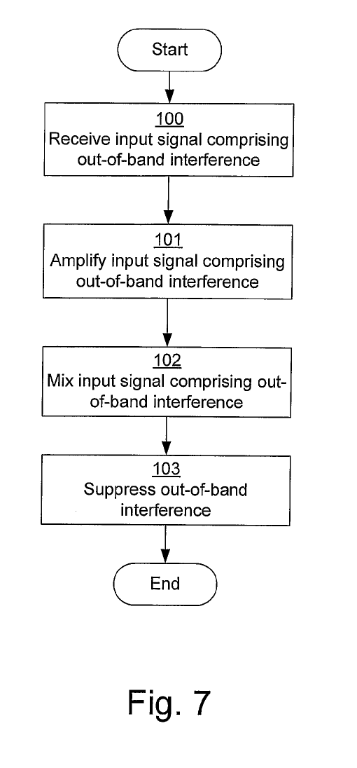

FIG. 7 illustrates the method according to the invention. In a first step 100, the input signal, which comprises out-of-band interference, is received at the input port of the N-phase radio receiver front-end. In step 101, the input signal comprising the out-of-band interference is amplified in the LNA 50. Then, in step 102, the amplified input signal and the out-of-band interference is mixed with the phase shifted LO signals, as discussed above, to generate a mixed signal comprising out-of-band interference. Finally, in step 103 the out-of-band interference of the mixed signal is suppressed, e.g. as discussed above by supplying the mixed signal to the frequency selective load, e.g. to the mixer loads comprising resistors and capacitors. If the frequency selective load comprises mixer loads, the capacitors 64a, 66a, 64b, 66b, 67a, 67b of the mixer loads may have values that are effective for suppressing the out-of-band interference. If said capacitors are variable capacitors, the method may comprise the step of setting the value of said capacitors. The method may also comprise the step of supplying the LO signals to the mixer cores, 51, 52. Furthermore, if the capacitors 76, 78 of the LC-tanks of the VCO are variable, the method may comprise the step of setting the value of said capacitors.

Reference has been made to an N-phase radio receiver front-end. The N-phase radio receiver may be a quadrature radio receiver front end. However, virtually any number of phases may be processed by suitably arranging the front-end. For example, six phases may be processed by adding an additional mixer core to the mixer arrangement 50a according to the embodiment of FIG. 4a. The number of different LO signals to be generated will thus be 6. The appropriate number of LO signals may be generated by the frequency divider or designing a VCO according to the principles of the embodiment of FIG. 4a. The number of phases to process may be denoted N. Thus, the number of different LO signals to generate will be N. The LO signals will thus be phase shifted by 360° /N relative each other.

The present invention may be e.g. be used for down converting RF signals to zero IF or low IF signals without using any band-select filter. Thus, the front-end according to the invention will have a compact design, and be cheap to manufacture.

It is an advantage of embodiments of the invention that no band-select filter is needed in the quadrature radio receiver front-end to suppress out-of-band interference. Thus, if said front-end is implemented using on-chip technology, the production cost may be lowered compared to a conventional radio receiver front-end having a band-select filter provided either on- or off-chip.

The present invention has been described above with reference to specific embodiments. However, other embodiments than the above described are equally possible within the scope of the invention. The different features of the invention may be combined in other combinations than those described. The invention is only limited by the appended patent claims.

1. An N-phase radio receiver front-end for converting an input signal having a first frequency to an output signal having a second frequency, comprising an input port, a low noise amplifier (50, 60) having an input port and an output port, a mixer arrangement (50a) having an input port and an output port, and a signal generator adapted to generate N local oscillator signals and being operatively connected to the mixer arrangement characterized in that the input port of the N-phase radio receiver front-end is directly connected to the input port of the low noise amplifier (50, 60);
the mixer arrangement (50a) is a current mode mixer arrangement;
the output port of the low noise amplifier is directly connected to the input port of the mixer arrangement; and
the signal generator is adapted to generate N phase shifted local oscillator signals.

2. The N-phase radio receiver front end according to claim 1, wherein the mixer arrangement (50a) includes N/2 mixer cores (51, 52), each mixer core having an input terminal connected directly to the input port of the mixer arrangement.

3. The N-phase radio receiver front-end according to claim 2, wherein said mixer cores (51, 52) are single-balanced mixer cores or double balanced mixer cores.

4. The N-phase radio receiver front end according to any of the previous claims, wherein said low noise amplifier is a differential amplifier (160a, 160b) or a single-ended amplifier (60).

5. The N-phase radio receiver front-end according to claim 2 or 3, wherein each mixer core (51, 52) comprises two or four transistors (61a, 62a, 61b, 62b, 161a, 161b, 161c, 161c, 162a, 162b, 162c, 162d), the transistors of each mixer core being responsive to two different local oscillator signals.

6. The N-phase radio receiver front-end according to any of the previous claims, wherein the signal generator is an oscillator for providing the local oscillator signals for driving the mixer arrangement (50a).

7. The N-phase radio receiver front-end according to any of the previous claims, wherein the signal generator is an oscillator operatively connected to the mixer arrangement (50a) by means of transformers (75, 77, 81, 82) for providing the local oscillator signals at local oscillator input terminals of said mixer arrangement (50a).

8. The N-phase radio receiver front end according to claim 7, wherein the oscillator is a quadrature oscillator for providing quadrature local oscillator signals.

9. The N-phase radio receiver front-end according to claim 7 or 8, wherein the oscillator comprises LC-tanks, each LC-tank being provided by an inductor (75, 77) and a capacitor (76, 78).

10. The N-phase radio receiver front-end according to claim 9, wherein the inductors (75, 77) of the LC-tanks provide primary windings of the transformers, and wherein inductors (81, 82) connected to the local oscillator input terminals of the mixer arrangement (50a) provide secondary windings of said transformers.

11. The N-phase radio receiver front-end according to claim 9 or 10, wherein the capacitor (76, 78) of each LC-tank is a variable capacitor for adjusting the frequency of the local oscillator signals.

12. The N-phase radio receiver front-end according to any of the claims 1 to 6, wherein the signal generator comprises a high frequency oscillator (90) and a frequency divider (91) for providing the local oscillator signals.

13. The N-phase radio receiver front-end according to claim 12, wherein the frequency divider (91) is arranged to provide N local oscillator signals having a duty cycle of substantially 1/N each, and only one of said local oscillator signals being in the high state at a time.

14. The N-phase radio receiver front-end according to any of the previous claims, wherein the low noise amplifier (50) comprises at least one input transistor (60) connected in a common gate or a common base configuration.

15. The N-phase radio receiver front-end according to any of the previous claims, further comprising an active or passive frequency selective load connected to output ports of the mixer arrangement (50a).

16. The N-phase radio receiver front-end according to claim 15, wherein the frequency selective load comprises current to voltage conversion means (53, 54, 63a, 64a, 65a, 66a, 63b, 64b, 65b, 66b, 67a, 67b).

17. The N-phase radio receiver front-end according to claim 16, wherein an output port of a first mixer core (51) of the mixer arrangement (50a) is connected to a first current to voltage conversion means and an output port of a second mixer core (52) of the mixer arrangement is connected to a second current to voltage conversion means.

18. The N-phase radio receiver front-end according to claim 17, wherein each current to voltage conversion means (53, 54, 63a, 64a, 65a, 66a, 63b, 64b, 65b, 66b, 67a, 67b) comprises a mixer load connected to a respective output port of the mixer cores and signal grounding means, respectively.

19. The N-phase radio receiver front-end according to claim 18, wherein each mixer load is a resistor (63a, 65a, 63b, 65b) connected in parallel with a capacitor (64a, 66a, 64b, 66b), and a capacitor (67a, 67b) connected between the output terminals of each mixer core.

20. The N-phase radio receiver according to claim 19, wherein the capacitors (64a, 66a, 64b, 66b, 67a, 67b) of each mixer load has a value which is effective for suppressing out-of-band interference of a signal input to the radio receiver front-end when said signal has been mixed.

21. The N-phase radio receiver front-end according to claim 20, wherein the capacitance of each capacitor (64a, 66a, 64b, 66b, 67a, 67b) of each mixer load is variable for suppressing out-of-band interference of input signals of different received signal bandwidths.

22. The N-phase radio receiver front-end according to any of the previous claims, further comprising a current device (68) connected to the input port of the low noise amplifier and grounding means.

23. The N-phase radio receiver front-end according to claim 22, wherein the current device (68) is an inductor, a resistor, or a transistor connected as a current source.

24. The N-phase radio receiver front end according to any of the previous claims, wherein said N-phase radio receiver front end is a quadrature radio receiver front-end.

25. Use of an N-phase radio receiver front-end according to any of the previous claims in a wireless electronic communication apparatus (1) for converting an input signal having a first frequency to a signal having a second frequency.

26. A wireless electronic communication apparatus (1) comprising an N-phase radio receiver front-end according to any of claims 1-24.

27. The wireless electronic communication apparatus according to claim 23, wherein the wireless electronic communication apparatus (1) is a mobile radio terminal, a pager, a communicator, an electronic organizer or a smartphone.

28. The wireless electronic communication apparatus according to claim 23, wherein the wireless electronic communication apparatus is a mobile telephone (1).

29. A method for converting an input signal having a first frequency to an output signal having a second frequency in an N-phase radio receiver front-end, the method comprising the step of receiving the input signal at an input port of the radio receiver front-end, characterized by the steps of
amplifying the input signal comprising out-of-band interference in a low noise amplifier (50, 60);
mixing the input signal and the out-of-band interference with a plurality of phase shifted local oscillator signals having a second frequency in a current mode mixer arrangement (50a) to generate a mixed signal having the second frequency.

30. The method according to claim 29, wherein the mixed signal comprises out-of-band interference; and the method further comprises suppressing the out-of-band interference of the mixed signal using a frequency selective load.

31. The method according to claim 30, wherein the step of suppressing comprises supplying the mixed signal comprising the out-of-band interference to a frequency selective load (53, 54, 63a, 64a, 65a, 66a, 63b, 64b, 65b, 66b, 67a, 67b), which is connected to an output port of the mixer arrangement (50a) and signal grounding means, respectively.

32. The method according to claim 31, wherein the step of suppressing comprises supplying the mixed signal comprising the out-of-band interference to a resistor (63a, 65a, 63b, 65b) connected in parallel with a capacitor (64a, 66a, 64b, 66b), and to a capacitor (67a, 67b) connected between output terminals of the mixer arrangement.

33. The method according to claim 32, wherein the step of suppressing comprises suppressing by means of the capacitors (64a, 66a, 64b, 66b, 67a, 67b), which have values that are effective for suppressing out-of-band interference of the mixed signal.

34. The method according to claim 33, further comprising adjusting the capacitance of capacitors (64a, 66a, 64b, 66b, 67a, 67b), which are variable capacitors, of the frequency selective load for suppressing out-of-band interference of mixed input signals of different received signal bandwidths.

35. The method according to any of the claims 29 to 34, further comprising the step of generating the local oscillator signals, and supplying said generated local oscillator signals to a first and a second single balanced or double balanced mixer cores (51, 52) of the mixer arrangement (50a).

36. The method according to claim 35, further comprising adjusting the capacitance of a capacitor (76, 78) of an oscillator connected to the mixer arrangement (50a) for adjusting the frequency of said local oscillator signals.
